(19) United States
(12) Patent Application Publication
(10) Pub. No.: US 2005/0143067 A1
(43) Pub. Date: Jun. 30, 2005

(54) Method and arrangement for personalization of series and applications in telecommunication networks using a user profile web portal

(76) Inventors: Thanh Van Do, Oslo (NO); Anne Marie Hartvigsen, Oslo (NO)

Correspondence Address: SCHNECK & SCHNECK, P.O. BOX 2-E, SAN JOSE, CA, 95109-0005, US

(21) Appl. No.: 10/515,674

(22) PCT Filed: May 30, 2003
(86) PCT No.: PCT/NO03/00176

Related U.S. Application Data
(60) Provisional application No. 60/384,089, filed on May 31, 2002.

(30) Foreign Application Priority Data
Oct. 7, 2002 (NO) 20024840

(51) Int. Cl. H04Q 7/20

(52) U.S. Cl. 455/432.3

(57) ABSTRACT

A method and arrangement for personalization of services and applications in telecommunication networks are disclosed. The inventive solution means that a user is able to access his/hers services and applications from any terminal in any network. The following features are included in the inventive solution: All the user's settings and preferences for all his services and applications are incorporated in a User profile. The User Profile is made available in the world-Wide-Web as an XML web service (12). The user is allowed to access and modify his/her profile via a User Profile Web Portal (10). Services and applications can access the user profile via a Web interface.

### TECHNICAL FIELD

This invention relates to the use of services and applications from terminals in telecommunication networks.

### TECHNICAL BACKGROUND

The success of mobile communication expressed by the explosion both in the number of mobile phones and the number of mobile subscriptions can only be explained by the user's demand for freedom and flexibility. The fact of being able to communicate anytime and anywhere is in itself very valuable to the users. Such a demand will soon be extended to comprise other services than just voice communication. In fact, after experiencing exciting data applications on the Internet the user will inevitably expect to be able to access them anywhere at anytime and on any terminal either fixed or mobile.

In addition, he/she will probably expect to access the same application or at least be able to recognise the application that he/she is familiar with at home. The functionality, the behaviour, the presentation, the look and feel, the preferences and settings, etc. should preferably be the same or as close as possible to what he/she is used to. This is possible to achieve but requires that the user set up and personalize for each application/service and restore the original settings after use. However, it is a boring and time consuming task that he/she would prefer to be exempt from. For a non-technical user such a task can neither be required nor accepted.

There is an obvious demand for automatic set-up for every services and applications according to the user's preferences no matter when, where or on which device the user is using the service or application.

There is per today no known solution that satisfies the following requirements:
1. Always allows automatic set up of every service or application according to the user's preferences without the intervention of the user, independently of the time, the location, the network and the device in use.
2. Allows the preservation of the user's setting and preferences for any services and applications independently of the time, the location, the network and the device in use.
3. Supports both communication services that allow communications between human beings such as voice telephony, multimedia telephony, conference, etc. and data services that offers computing services to a user such word processor, spreadsheet, database, etc.
4. Supports all services and applications of the user no matter where the services and applications are located, i.e. in the home operator's domain, the visiting operator's domain, the 3^{rd} party domain or locally on the user's devices.

There exists, however, systems that satisfy partially the requirements stated above. In telecommunication systems, in order to allow the customization of services, a user profile is introduced to capture the preferences and settings of the users as in the case of Universal Personal Telecommunication (UPT) (ITU-TS, 1994) and in Telecommunications Information Networking Architecture (TINA) (TINA Consortium, 1997). In Global System for Mobile Communications (GSM), such a user profile is called Subscriber Data or Subscriber Profile (ETSI/3GPP, 1998). The user profile contains information that is required for service provisions, identification, authentication, routing, call handling, charging, subscriber tracing, operation, and maintenance purposes.

Telecom user profiles as defined have many limitations. The user profile is intended for customisation of the main service, namely voice communication or telephony, and its supplementary services, e.g. call forwarding, call answering, etc. It is also stored within the operator's system and is not available to 3rd party applications or services.

### BRIEF SUMMARY OF THE INVENTION

This invention proposes a method and arrangement that satisfies all the four requirements stated above.

In particular it is an object of the present invention to provide an overall system architecture which allows an automatic set up of the user's preferences for all services and applications independently of the time, location, network and devices that the user is currently using.

The scope of the invention appears from the appended patent claims.

### BRIEF DESCRIPTION OF THE DRAWINGS

A detailed account of the inventive system will now be given in reference to the appended drawings, in which

FIG. 1 shows the overall architecture of a system according to the present invention,

FIG. 2 is a diagram showing the structure of a user profile as utilized in the present invention,

FIG. 3 is showing user profile access by services and applications,

FIG. 4 is showing user profile access via a User Profile Web Portal.

### DETAILED DESCRIPTION OF THE INVENTION

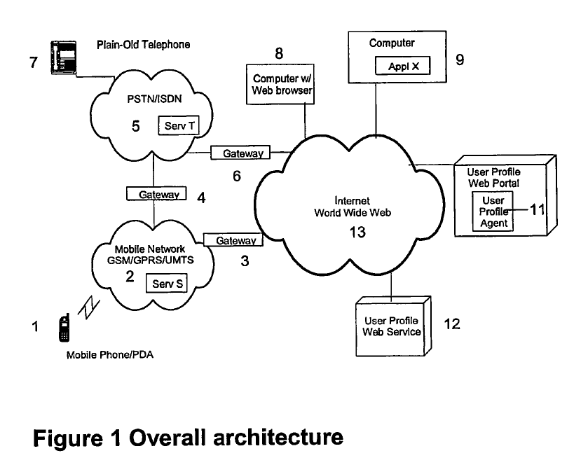

The example in FIG. 1 shows a telecommunication system including a mobile communication network 2 with a terminal 1. The terminal can e.g. be a mobile phone or a PDA. The system also includes a fixed network 5 with a terminal 7, here an ordinary telephone. The networks are interconnected with a gateway 4. Each network 2, 5 is is connected to the Internet 13 via gateways 3, 6.

As mentioned above, it is an objective of the invention to provide user access to preferred services and applications no matter where he/she is located. In order to fulfill this objective, the following features are included in the inventive solution:
All the user's settings and preferences for all his services and applications are incorporated in a User profile.
The User Profile is made available in the World-Wide-Web as an XML web service 12 that we call User Profile XML Web service.
The user is allowed to access and modify his/her profile via a User Profile Web Portal 10.
The system includes a User Profile Agent 11 that
   fetches the User Profile from the User Profile Web Service 12.
   carries out the settings of the services and applications according to the user's preferences and save the original settings.
   sends the modified profile back to User Profile Web Service 12 for storage when the user terminates his session.
   restores the original/default settings of the personalized applications.

The two components introduced in the Internet and the World-Wide-Web; the User Profile Web Service 12 and the User Profile Web Portal 10 that are both web servers and can be addressed using an URI (Uniform Resource Identifier).

The Definition of the User Profile

The preferences and settings of a user are captured in the user profile. For each user there will be allocated one unique user profile.

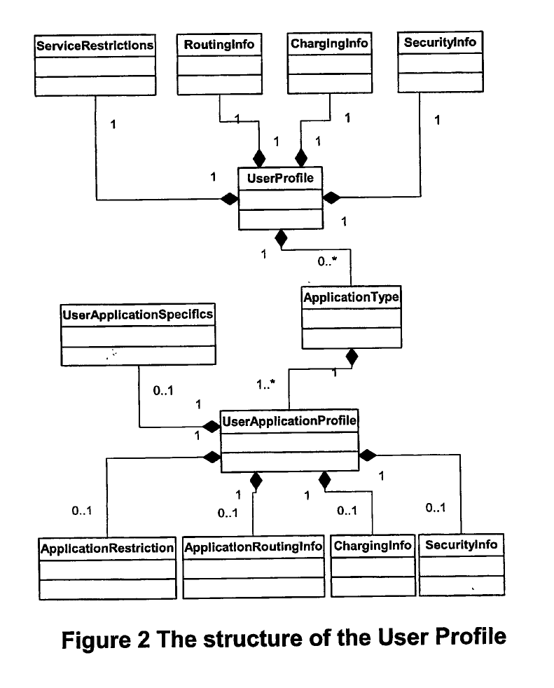

In order to allow the users access to multiple applications and services anytime, anywhere and on any terminal, the content of the user profile needs to be extended to fulfil the following requirements (see UML class diagram, FIG. 2):
For each user the user profile must be expandable to incorporate the preferences and settings for any additional application or service that the user requires.
For each application the user profile must contain the information necessary for the presentation of the application on the terminal types requested by the user.
For each application the user profile must contain application restrictions which specify the usage restrictions.

The user profile must incorporate personal data such as address book, telephone list, bookmarks, calendar appointments, etc.

The UserProfile has five components: ServiceRestriction, RoutingInfo, ChargingInfo, SecurityInfo and ApplicationType.

The UserProfile contains personal data of the user such as: name, address, phone number, etc.

ServiceRestriction has attributes such as:
Roaming restriction
Time restriction
credit limit
Maximum number of terminal addresses for group registration for incoming applications
Incoming screening
Outgoing screening
List of subscribed services

RoutingInfo has attributes such as
Forwarding activation status
Registered terminal address for incoming applications
A linked-registered terminal address
Default terminal address for incoming applications
Routing by applications originating area
Routing by calling party identity
Time-dependent routing
Routing on “busy” condition
Routing on “no answers condition
Default duration (or number of calls) for incoming applications registration

ChargingInfo has attributes such as
Default charging reference location
Charging option selected
Temporary charging reference location
Advice of charge activation status

SecurityInfo has attributes such as
Authentication procedures subscribed
Security options subscribed
Type of authentication procedures activated
Max number of failed authentication attempts
Password
   ApplicationType

The UserProfile may contain zero or more ApplicationTypes. UserApplicationType may be e.g. spreadsheet application, word processor, e-mail client, Web browser, etc. A type should be defined with a unique ID defined by the User Profile Operator or by international standards.

UserApplicationProfile

Each ApplicationType may have zero or more UserApplicationProfiles. The UserApplicationProfile component is to enable customisation of an application, e.g. Internet Explorer, Netscape, Opera, etc. For each application (run in a service session), there may hence be assigned zero or one UserApplicationProfile. The application in the UserApplicationProfile should be identified with a unique ID representing also the version of the application. Hence, Netscape version x should have a different ID than Netscape version y.

The UserApplicationProfile may contain zero or one ApplicationRestriction, ApplicationRoutingInfo, ApplicationChargingInfo, ApplicationSecurityInfo and UserApplicationSpecifics. It is therefore possible to specify the restrictions, routing, charging, and security options for each application. If one or more of these components are not specified for the application, the corresponding components in the UserProfile (ServiceRestriction, RoutingInfo, etc.) can be applied instead.

UserApplicationSpecifics

The UserApplicationProfile may also contain zero or one UserApplicationSpecifics—a component that contains application specific data. ApplicationType and the specific application decide the structure and content of this component. As the Operator adds new application types and applications to the database, the structure of the UserApplicationSpecifics must be defined accordingly. For example it might be specified that all applications of type Web browser can store Bookmarks, History and Cookies in UserApplicationSpecifics. The format for storing this information depends on the application. For example Internet Explorer bookmarks will be saved in another format than Netscape bookmarks.

The reason for specifying ApplicationType is because it enables one application to use data belonging to another application, provided that the first application knows how to convert the data to its own format. If a user has stored bookmarks in Netscape format, but switches to e.g. Opera, the User Profile will recognise that the application type is the same, and that the Opera browser might want to use the Netscape bookmarks. If Opera has a method for importing Netscape bookmarks, the User Profile might provide the Netscape bookmarks to the Opera browser.

Example of Application Types

Mail

Applications: Outlook, Eudora, Pine, etc.

User Application Specifics: mailing list
Telephony

Applications: Fixed telephony, Mobile telephony, IP telephony, conference, etc.
User Application Specifics: telephone list
Calendar

Applications: Outlook, Calendar in PDA, etc.—User Application Specifics: calendar data.

The User Profile Web Service

Objective

The objective of the User Profile Web Service is to make the user profile universally available in the World-Wide Web

Functionality

This component has the following functions:
Assumes the storage and management of the User Profile.
Provides a SOAP interface called I1 on the World-Wide-Web such that any service or application located on the Internet or the fixed networks like PSTN, ISDN, etc. or mobile networks like GSM, GPRS, UMTS, etc. can query its UserApplicationProfile
Provides a SOAP interface called 12 with the User Profile Web Portal such the User Profile Web Portal can query the full User Profile.
Provides an OAM (Operation and Maintenance) interface which allows the definition of new users, new application type, new application ID, etc.
   Interface I1 for Application Profile

It is worth noting that authentication and authorization need to be performed before allowing this usage of this interface.

This interface allows authorized entities to query and write back the UserApplicationProfile, by using two function calls:

Method getUser ApplicationProfile (in UserID, in applType, in applID, in identification, out UserApplProfile)

Method setUser ApplicationProfile (in UserID, in applType, in applID, in identification, in UserApplProfile out Ack)

UserID: The User's ID

applType: The ApplicationType ID

applID: The ApplicationID (incl. Version ID)

identification: Token identifying the requestor

UserApplProfile: The UserApplicationProfile of the right user and application (according to in UserID, in applType, in applID)

Ack: Acknowledgement

Interface 12 for User Profile

It is worth noting that authentication and authorization need to be performed before allowing this usage of this interface.

This interface allows authorized entities to query and to write back the whole User Profile, with the following function calls:

Method getUser Profile (in UserID, in applType[ ], in applID[ ], in identification, out UserProfile)

Method setUser Profile (in UserID, in applType[ ], in applID[ ], in identification, in UserProfile out Ack)

UserID: The User's ID

applType[ ]: ApplicationType IDs. The applicationone can request information for one or more of the applications defined for the user

applID[ ]: ApplicationIDs (incl. Version IDs). The application can request information for one or more of the applications defined for the user

identification: Token identifying the requestor

UserApplProfile: The UserProfile of the right user, including information for the applications requested (specified in in UserID, in applType[ ], in applID[ ])

Ack: Acknowledgement

Implementation

We propose to implement the User profile as a service that makes an extendable user profile available to applications through a SOAP interface.

SOAP encoding of parameters and data sent to and from the service offers language and platform transparency, so that the service interface is available to any application on any device.

The appendix shows an example on how the methods offered by the User Profile Web Service can be implemented, written in SOAP.

The User Profile Web Portal

Objective

The objective of the User Profile Web Portal is to enable automatic preference settings.

Functions

This component has the following functions:
Provides a user interface on web browser (e.g.

Explorer, Netscape, etc.) such that the user can use a device (PC, workstation, WAP phone) with a browser to access the User Profile Web Portal.
Has a User Agent Profile which assumes the responsibility:
   Interact with the User Profile Web Service to fetch the User Profile
   to set up the services and applications using the User Profile obtained from the User Profile Web Service
   to save the original settings of the personalized services and applications
   to send the modified User profile back to the User Profile Web Service when the user terminates his session.
   to restore the original settings for the respective service and applications.
      Use Scenarios
      Use scenario for the interface II

The User Profile Web Service provides an interface II such that services and applications can access it no matter where they are located. The user may use a service S offered by the mobile network, a service T offered by the fixed network or application X running on a computer connected to the Internet. In order to be able to carry out the set up according the user's preferences, these applications need to get its User Application Profile. They can use interface Il to make the query to the User Profile Web Service.

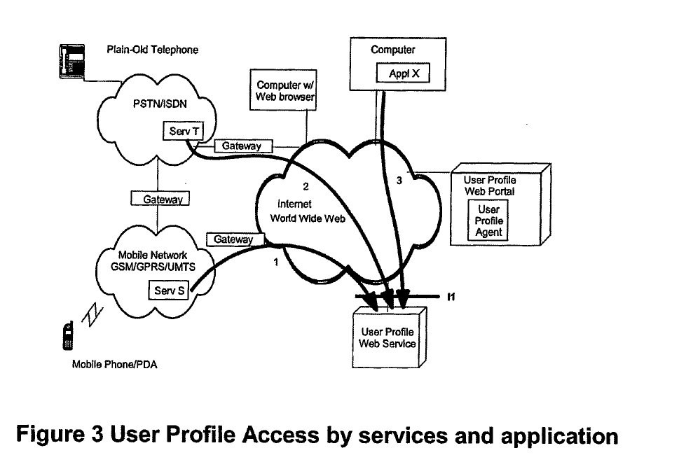

As shown in FIG. 3, through interface II, a service S residing in the Mobile Network System or a service T residing in the fixed networks systems or an application X running on a computer connected to the Internet can query its User Application Profile.

Use scenario for Interface 12

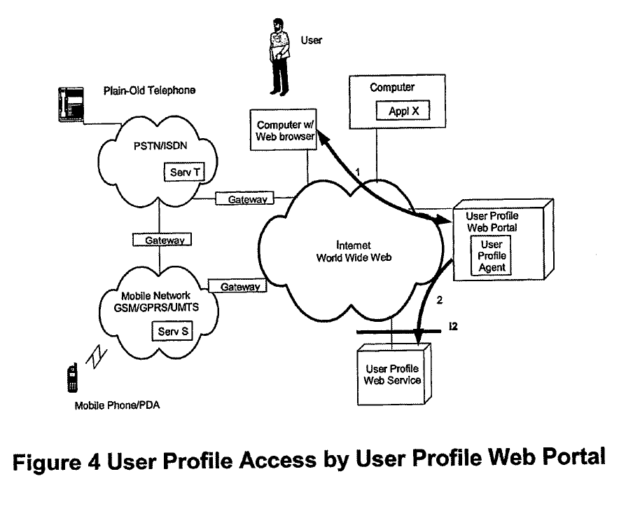

As shown in FIG. 4, this scenario starts as follows:
1. The user uses a device with a browser and is visiting the URL of the User Profile Web Portal. Although a computer is shown in the figure, the user may use any device having a browser such as a WAP phone, a PDA, etc.
2. He/she authenticates himself. Sufficiently strong authentication is necessary.
3. Assuming that authentication is successful, the User Profile Agent requests the User Profile of the user via the interface I1. It is worth noting that there is also a need for authentication, authorization and a secured channel between the User Profile Web Service and the User Service Web Portal.
4. The User Profile Agent consults the User Profile to find out what applications are relevant for the setting of the user's preferences.
5. The User Profile Agent interacts with the device currently used by the user to find out whether the wanted application is installed on the device. If not it will try to find in the domain where the device is connected to. If not, it will consult the home domain of the user.
6. For each application, the User Profile agent will perform the preference settings by installing the user's preferences captured in the UserApplicationSpecifics. The application is now personalized according the user's preferences.
7. The user finishes his works. The User Profile Agent is notified. This can be done by the user to User Profile Web Portal or by the logging out process.
8. The User Profile Agent will save the modified User Application Profile onto the User Profile Web Service.
9. The User Profile Agent will restore the original settings of the personalized applications.

The set up of preferences is hence concluded.

APPENDIX
Implementation of the methods offered by the User Profile
Web Service in SOAP:
SOAP Message structure: getUserApplicationProfile
Request Message:
<?xml version=“1.0” encoding=“utf-8”?>
<soap:Envelope
xmlns:xsi=http://www.w3.org/2001/XMLSchema-instance
xmlns:xsd=http://www.w3.org/2001/XMLSchema
xmlns:soap=“http://schemas.xmlsoap.org/soap/envelope/”>

<soap:Body>

<getUserApplicationProfile

xmlns=“http://operators.unique.namespace.identifier”>

<userID>The user's unique ID</userID>

<applType>The ID of the application Type</applType>

<applicationID>The application's unique

ID</applicationID>

<identification>Identification</identification>
</getUserApplicationProfile>

</soap:Body>

</soap:Envelope>
Response Message:
<?xml version=“1.0” encoding=“utf-8”?>
<soap:Envelope
xmlns:xsi=http://www.w3.org/2001/XMLSchema-instance
xmlns:xsd=http://www.w3.org/2001/XMLSchema
xmlns:soap=“http://schemas.xmlsoap.org/soap/envelope/”>

<soap:Body>

<getUserApplicationProfileResponse>
<getUserApplicationProfileResult

xmlns=“http://operators.unique.namespace.identifier”>
<UserApplicationProfile>
<UserApplicationProfileInfo>

<Field1>information</Field1>

<Field2>information</Field2>

etc...

</UserApplicationProfileInfo>
<UserApplicationSpecificInfo>

<Structure1>

<Field1>information</Field1>

<Field2>information</Field2>

etc...

</Structure1>

<Structure2>

<Field1>information</Field1>

<Field2>information</Field2>

etc...

</Structure2>
etc...

</UserApplicationSpecificInfo>

</UserApplicationProfile>

</getUserApplicationProfileResult>

</getUserApplicationProfileResponse>

</soap:Body>

</soap:Envelope>
SOAP Message structure: setUserApplicationProfile
Request Message:
<?xml version=“1.0” encoding=“utf-8”?>
<soap:Envelope
xmlns:xsi=http://www.w3.org/2001/XMLSchema-instance
xmlns:xsd=http://www.w3.org/2001/XMLSchema
xmlns:soap=“http://schemas.xmlsoap.org/soap/envelope/”>

<soap:Body>

<setUserApplicationProfile

xmlns=“http://operators.unique.namespace.identifier”>

<userID>The user's unique ID</userID>

<applType>The ID of the application Type</applType>

<applicationID>The application's unique

ID</applicationID>

<identification>Identification</identification>

<UserApplicationProfile>
<UserApplicationProfileInfo>

<Field1>information</Field1>

<Field2>information</Field2>
etc...

</UserApplicationProfileInfo>
<UserApplicationSpecificInfo>

<Structure1>

<Field1>information</Field1>

<Field2>information</Field2>

etc...

</Structure1>

<Structure2>

<Field1>information</Field1>

<Field2>information</Field2>

etc...

</Structure2>
etc...

</UserApplicationSpecificInfo>

</UserApplicationProfile>

</setUserApplicationProfile>

</soap:Body>

</soap:Envelope>
Response Message:
<?xml version=“1.0” encoding=“utf-8”?>
<soap:Envelope
xmlns:xsi=http://www.w3.org/2001/XMLSchema-instance
xmlns:xsd=http://www.w3.org/2001/XMLSchema
xmlns:soap=“http://schemas.xmlsoap.org/soap/envelope/”>

<soap:Body>

<setUserApplicationProfileResponse>

<setUserApplicationProfileResult

xmlns=“http://operators.unique.namespace.identifier”>

<Ack>True or False<Ack>

</setUserApplicationProfileResult>

</setUserApplicationProfileResponse>

</soap:Body>

</soap:Envelope>
SOAP Message structure: getUserProfile
Request Message:
<?xml version=“1.0” encoding=“utf-8”?>
<soap:Envelope
xmlns:xsi=http://www.w3.org/2001/XMLSchema-instance
xmlns:xsd=http://www.w3.org/2001/XMLSchema
xmlns:soap=“http://schemas.xmlsoap.org/soap/envelope/”>

<soap:Body>

<getUserProfile

xmlns=“http://operators.unique.namespace.identifier”>
<userID>The user′s unique ID</userID>
<application>

<applType>First application Type</applType>

<applicationID>First application ID</applicationID>

</application>

<application>

<applType>Sec. application Type </applType>

<applicationID>Sec. application ID</applicationID>

</application>
etc...

<identification>Identification</identification>
</getUserProfile>

</soap:Body>

</soap:Envelope>
Response Message:
<?xml version=“1.0” encoding=“utf-8”?>
<soap:Envelope
xmlns:xsi=http://www.w3.org/2001/XMLSchema-instance
xmlns:xsd=http://www.w3.org/2001/XMLSchema
xmlns:soap=“http://schemas.xmlsoap.org/soap/envelope/”>

<soap:Body>

<getUserProfileResponse>

<getUserProfileResult

xmlns=“http://operators.unique.namespace.identifier”>
<UserProfile>

<UserProfileInfo>

<Field1>information</Field1>

<Field2>information</Field2>

etc...

</UserProfileInfo>
<ApplicationInfo>

<UserApplicationProfileInfo>

<Field1>information</Field1>

<Field2>information</Field2>

etc...

</UserApplicationProfileInfo>
<UserApplicationSpecificInfo>

<Structure1>

<Field1>information</Field1>

<Field2>information</Field2>

etc...

</Structure1>

<Structure2>

<Field1>information</Field1>

<Field2>information</Field2>

etc...

</Structure2>
etc...

</UserApplicationSpecificInfo>

</ApplicationInfo>
<ApplicationInfo>

<UserApplicationProfileInfo>

<Field1>information</Field1>

<Field2>information</Field2>

etc...

</UserApplicationProfileInfo>
<UserApplicationSpecificInfo>

<Structure1>

<Field1>information</Field1>

<Field2>information</Field2>

etc...

</Structure1>

<Structure2>

<Field1>information</Field1>

<Field2>information</Field2>

etc...

</Structure2>
etc...

</UserApplicationSpecificInfo>

</ApplicationInfo>

</UserProfile>

</getUserProfileResult>

</getUserProfileResponse>

</soap:Body>

</soap:Envelope>
SOAP Message structure: setUserProfile
Request Message:
<?xml version=“1.0” encoding=“utf-8”?>
<soap:Envelope
xmlns:xsi=http://www.w3.org/2001/XMLSchema-instance
xmlns:xsd=http://www.w3.org/2001/XMLSchema
xmlns:soap=“http://schemas.xmlsoap.org/soap/envelope/”>

<soap:Body>

<setUserProfile

xmlns=“http://operators.unique.namespace.identifier”>
<userID>The user's unique ID</userID>
<application>
<applType>1st application Type</applType>
<applicationID>1st application ID</applicationID>

</application>

<application>

<applType>2nd application Type </applType>

<applicationID>2nd application ID</applicationID>

</application>
etc...

<identification>Identification</identification>

<UserProfile>

<UserProfileInfo>

<Field1>information</Field1>

<Field2>information</Field2>

etc...

</UserProfileInfo>
<ApplicationInfo>

<UserApplicationProfileInfo>

<Field1>information</Field1>

<Field2>information</Field2>

etc...

</UserApplicationProfileInfo>
<UserApplicationSpecificInfo>

<Structure1>

<Field1>information</Field1>

<Field2>information</Field2>

etc...

</Structure1>

<Structure2>

<Field1>information</Field1>

<Field2>information</Field2>

etc...

</Structure2>
etc...

</UserApplicationSpecificInfo>

</ApplicationInfo>
<ApplicationInfo>

<UserApplicationProfileInfo>

<Field1>information</Field1>

<Field2>information</Field2>

etc...

</UserApplicationProfileInfo>
<UserApplicationSpecificInfo>

<Structure1>

<Field1>information</Field1>

<Field2>information</Field2>

etc...

</Structure1>

<Structure2>

<Field1>information</Field1>

<Field2>information</Field2>

etc...

</Structure2>
etc...

</UserApplicationSpecificInfo>

</ApplicationInfo>

</UserProfile>

</setUserProfile>

</soap:Body>

</soap:Envelope>
Response Message:
<?xml version=“1.0” encoding=“utf-8”?>
<soap:Envelope
xmlns:xsi=http://www.w3.org/2001/XMLSchema-instance
xmlns:xsd=http://www.w3.org/2001/XMLSchema
xmlns:soap=“http://schemas.xmlsoap.org/soap/envelope/”>

<soap:Body>

<setUserProfileResponse>

<setUserProfileResult

xmlns=“http://operators.unique.namespace.identifier”>

<Ack>True or False<Ack>

</setUserProfileResult>

</setUserProfileResponse>

</soap:Body>

</soap:Envelope>

1. A method for personalization of services and applications in a telecommunication network, in which the services and applications are accessed by a user from a user terminal, the network being connected to other networks as well as the Internet through gateways, said method being characterized in the following steps:
incorporating all the user's settings and preferences for all his services and applications in a User profile, to make making the User Profile available in the World-Wide-Web as an a User Profile XML Web service (12), tu let letting the user access and modify his/her profile via a User Profile Web Portal (10), to having a User Profile Agent (11) that is adapted to fetch the User Profile from the User Profile Web Service (12), carry carrying out the settings of the services and applications according to the user's preferences and saving the original settings, and sending the modified profile back to User Profile Web Service (12) for storage when the user terminates his session.

2. A method for personalization of services and applications in telecommunication networks, the services and applications being accessed by a user from a user terminal, the network being connected to other networks as well as the internet through gateways, said method being characterized in the following steps:
incorporating all the user's settings and preferences for all his services and applications in a User profile,
making the User Profile available in the World-Wide-Web as a User Profile XML Web service, and letting services and applications access the user profile through an interface on said User Profile XML Web service.

3. An arrangement for personalization of services and applications in a telecommunication network, said services and applications being accessed by a user from a user terminal, said network being connected to other networks as well as the internet through gateways,
characterized in a first Web server running a User Profile XML Web service, said service storing and managing a User Profile, making the User Profile available in the World-Wide-Web, said services and applications being accessed by a user from a user terminal, said User Profile incorporating the user's settings and preferences for his/her services and applications.

4. The arrangement as claimed in claim 3, characterized in that the User Profile contains information necessary for the presentation of applications on any terminal type requested by the user.

5. The arrangement as claimed in claim 4, characterized in that said User Profile XML Web service is provided with a first interface on the Web such that any service or application located on the Internet or fixed networks or mobile networks can query the User Profile.

6. The arrangement as claimed in claim 5, characterized in a second Web server running a User Profile Web Portal, allowing the user to access and modify his/her profile via said portal.

7. The arrangement as claimed in claim 6, characterized in that said User Profile XML Web service is provided with a second interface with the User Profile Web Portal such that the User Profile Web Portal can query the User Profile.

8. The arrangement as claimed in claim 7, characterized in that said interfaces being SOAP interfaces.

9. The arrangement as claimed in claim 8, characterized in that said User Profile XML Web service is provided with a third interface for operation and maintenance.

10. The arrangement as claimed in claim 6, characterized in having a User Profile Agent situated in the User Profile Web Portal and adapted to
fetch the User Profile from the User Profile Web Service,
carry out the settings of the services and applications according to the user's preferences and save the original settings, and
send the modified profile back to User Profile Web Service for storage when the user terminates his session.
